(19) United States
(12) Patent Application Publication
(10) Pub. No.: US 2026/0301337 A1
(43) Pub. Date: Oct. 1, 2026

(54) Language-Guided Object Placement in 3D Scenes

(71) Applicant: Niantic Spatial, Inc., San Francisco, CA (US)

(72) Inventors: Ahmed Samir Hamed Abdelreheem, Thuwal (SA); Filippo Aleotti, London (GB); James Watson, London (GB); Zawar Imam Qureshi, London (GB); Gabriel J. Brostow, Bristol (GB); Sara Alexandra Gomes Vicente, London (GB); Guillermo Garcia-Hernando, London (GB)

(21) Appl. No.: 19/633,354

(22) Filed: Mar. 30, 2026

Related U.S. Application Data
(60) Provisional application No. 63/780,831, filed on Mar. 31, 2025.

(51) Int. Cl. G06T 19/00; H04N 21/854

(52) U.S. Cl. CPC G06T 19/006; H04N 21/854

(57) ABSTRACT

A content authoring tool applies a model to generate suggested positions in a 3D scene for 3D assets using natural language prompts provided by human designers. The model is given a representation of a 3D scene (e.g., a point cloud), a 3D asset, and a textual prompt describing where the 3D asset should be placed. The model extracts constraints on the positioning of the asset from the prompt and outputs one or more masks indicating valid positions for the 3D asset. One or more of the valid positions may be presented to a designer who provided the natural language prompt.

### CROSS-REFERENCE TO RELATED APPLICATIONS

This application claims the benefit of U.S. Provisional Patent Application No. 63/780,831, filed Mar. 31, 2025, which is incorporated by reference.

### BACKGROUND

### 1. Technical Field

The subject matter described relates generally to virtual content authoring, and, in particular, to identifying positions to place virtual objects using natural language instructions.

### 2. Problem

Recent developments with Large Language Models (LLMs) have led to an explosion in assisted design applications. In such applications, a human user provides a natural language prompt that provides parameters for a design task and a LLM generates one or more suggestions for the design task that can then be tweaked by the human user. One area in which there is interested in assisted design is the authoring of three-dimensional (3D) content for Augmented Reality (AR) and Virtual Reality (VR) scenes. Determining where to place different 3D assets in a 3D scene to meet design requirements provided in a prompt is a challenging task. Typically, there are multiple valid solutions and identifying valid solutions requires the model to understand 3D geometry and relationships. For example, the prompt “place the shoes under the shelf” requires an understanding of what shoes are, what the shelf is, and what under means in the geometrical context provided. Similarly, an instruction such as “place the asset in between the chair and the table, facing the television” requires reasoning about free space as well as 3D geometric relationships. These tasks involve not just an understanding of the scene geometry, but also the asset, such as the space required to fit the asset and the directionality of the asset (e.g., what does it mean for the asset to be “facing” something?).

### SUMMARY

The present disclosure describes a content authoring tool that applies a model to generate suggested positions in a 3D scene for 3D assets using natural language prompts. In various embodiments, the model is given a representation of a 3D scene (e.g., a point cloud), a 3D asset, and a textual prompt broadly describing where the 3D asset should be placed. The model extracts constraints on the positioning of the asset from the prompt and outputs one or more masks indicating valid positions for the 3D asset. In one embodiment, the masks include a placement mask, a rotation mask, and an anchors mask. The placement mask is defined over a point cloud representing the 3D scene and encodes regions where the 3D asset can be placed that satisfy the prompt. The rotation masks similarly indicates, for points in the point cloud, valid orientations of the 3D assets in view of the prompt. The anchors mask indicates anchor objects used in determining the validity of positions and rotations for the other two masks and is used as an auxiliary task to help the model identify anchors (i.e., requirements) in the prompt.

### BRIEF DESCRIPTION OF THE DRAWINGS

FIG. 1 depicts a representation of a virtual world having a geography that parallels the real world, according to one embodiment.

FIG. 2 depicts an exemplary interface of a parallel reality game, according to one embodiment.

FIG. 3 is a block diagram of a networked computing environment suitable for providing a content authoring system, according to one embodiment.

FIG. 4 is a block diagram of the content authoring system shown in FIG. 3, according to one embodiment.

FIG. 5 illustrates a machine learning architecture for object placement, according to at least some embodiments.

FIG. 6 depicts examples of decoder head architectures that product mask outputs for object placement, in accordance with some embodiments.

FIG. 7 shows examples of alternative scene-encoding strategies, in accordance with some embodiments.

FIG. 8 is a first example application of performing a language-guided placement of a 3D asset within a 3D scene.

FIG. 9 is a second example of performing natural language-guided placement of a 3D asset.

FIG. 10 is a flowchart of a process for authoring content using the content authoring system, according to one embodiment.

FIG. 11 illustrates an example computer system suitable for use in the networked computing environment of FIG. 1, according to one embodiment.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments are described in the context of a parallel reality game that includes augmented reality content in a virtual world geography that parallels at least a portion of the real-world geography such that player movement and actions in the real-world affect actions in the virtual world. The subject matter described is applicable in other situations where authoring 3D virtual content is desirable, such as creating AR experiences for museums, retail stores, public events, and the like. In addition, the inherent flexibility of computer-based systems allows for a great variety of possible configurations, combinations, and divisions of tasks and functionality between and among the components of the system.

### Example Location-Based Augmented Reality Application

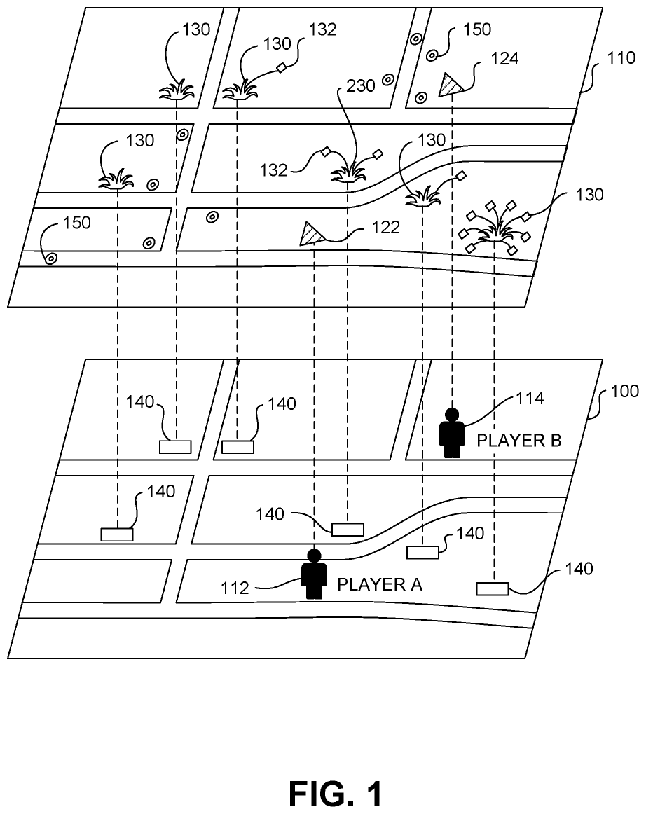

FIG. 1 is a conceptual diagram of a virtual world 110 that parallels the real world 100. As illustrated, the virtual world 110 includes a geography that parallels the geography of the real world 100. In particular, a range of coordinates defining a geographic area or space in the real world 100 is mapped to a corresponding range of coordinates defining a virtual space in the virtual world 110. The range of coordinates in the real world 100 can be associated with a town, neighborhood, city, campus, locale, a country, continent, the entire globe, or other geographic area. Each geographic coordinate in the range of geographic coordinates is mapped to a corresponding coordinate in a virtual space in the virtual world 110.

A user's position in the virtual world 110 corresponds to the user's position in the real world 100. For instance, in the example of a parallel-reality game, player A located at position 112 in the real world 100 has a corresponding position 122 in the virtual world 110. Similarly, player B located at position 114 in the real world 100 has a corresponding position 124 in the virtual world 110. As the users move about in a range of geographic coordinates in the real world 100, the users also move about in the range of coordinates defining the virtual space in the virtual world 110. In particular, a positioning system (e.g., a GPS system, a localization system, or both) associated with a mobile computing device carried by the user can be used to track a user's position as the user navigates the range of geographic coordinates in the real world 100. Data associated with the user's position in the real world 100 is used to update the user's position in the corresponding range of coordinates defining the virtual space in the virtual world 110. In this manner, users can navigate along a continuous track in the range of coordinates defining the virtual space in the virtual world 110 by simply traveling among the corresponding range of geographic coordinates in the real world 100 without having to check in or periodically update location information at specific discrete locations in the real world 100.

In some embodiments, the virtual world 110 includes virtual objects at locations that correspond to points of interest 140 in the real world 100. The points of interest 140 can be works of art, monuments, buildings, businesses, libraries, museums, or other suitable real-world landmarks or objects. Data regarding the points of interest in the real world (e.g., photographs, text descriptions, videos, audio recording) may be aggregated and stored for use in augmented reality (AR) or other location-based functionality tied to the virtual world 110. Data regarding points of interest 140 may also include information about how users interact with the points of interest, such as user IDs or numbers of users who engage in an AR experience at the point of interest, user IDs or numbers of users who submit information about the points of interest, gameplay results at the points of interest, or any other suitable information about user activity at or near the points of interest.

In the example of a location-based game, the game can include game objectives requiring players to travel to or interact with various virtual elements or virtual objects scattered at various virtual locations in the virtual world 110. A player can travel to these virtual locations by traveling to the corresponding location of the virtual elements or objects in the real world 100. For instance, a positioning system can track the position of the player such that as the player navigates the real world 100, the player also navigates the parallel virtual world 110. The player can then interact with various virtual elements and objects at the specific location to achieve or perform one or more game objectives.

A game objective may have players interacting with virtual elements 130 located at various virtual locations in the virtual world 110. These virtual elements 130 can be linked to points of interest 140 in the real world 100. The points of interest 140 can be works of art, monuments, buildings, businesses, libraries, museums, or other suitable real-world landmarks or objects. Interactions include capturing, claiming ownership of, using some virtual item, spending some virtual currency, etc. To capture these virtual elements 130, a player travels to the points of interest 140 linked to the virtual elements 130 in the real world and performs any necessary interactions (as defined by the game's rules) with the virtual elements 130 in the virtual world 110. For example, player A may have to travel to a landmark 140 in the real world 100 to interact with or capture a virtual element 130 linked with that particular landmark 140. The interaction with the virtual element 130 can require an action in the real world, such as taking a photograph or verifying, obtaining, or capturing other information about the landmark or object 140 associated with the virtual element 130.

Game objectives may require that players use one or more virtual items that are collected by the players in the location-based game. For instance, the players may travel the virtual world 110 seeking virtual items 132 (e.g., weapons, creatures, power ups, or other items) that can be useful for completing game objectives. These virtual items 132 can be found or collected by traveling to different locations in the real world 100 or by completing various actions in either the virtual world 110 or the real world 100 (such as interacting with virtual elements 130, battling non-player characters or other players, or completing quests, etc.). In the example shown in FIG. 1, a player uses virtual items 132 to capture one or more virtual elements 130. In particular, a player can deploy virtual items 132 at locations in the virtual world 110 near to or within the virtual elements 130. Deploying one or more virtual items 132 in this manner can result in the capture of the virtual element 130 for the player or for the team/faction of the player.

In one particular implementation, a player may have to gather virtual energy as part of the parallel reality game. Virtual energy 150 can be scattered at different locations in the virtual world 110. A player can collect the virtual energy 150 by traveling to (or within a threshold distance of) the location in the real world 100 that corresponds to the location of the virtual energy in the virtual world 110. The virtual energy 150 can be used to power virtual items or perform various game objectives in the game. A player that loses all virtual energy 150 may be disconnected from the game or prevented from playing for a certain amount of time or until they have collected additional virtual energy 150.

In some embodiments, the location-based game is a massive multi-player parallel-reality game where every participant in the game shares the same virtual world 110. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing their locations.

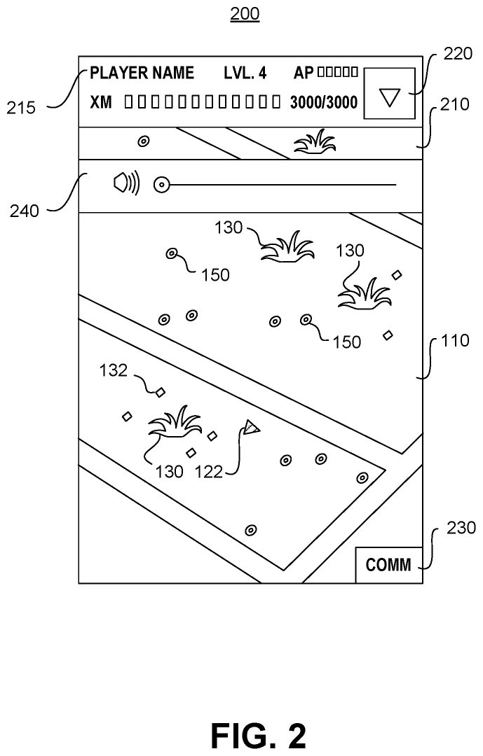

FIG. 2 depicts one embodiment of a game interface 200 that can be presented (e.g., on a player's smartphone) as part of the interface between the player and the virtual world 110. The game interface 200 includes a display window 210 that can be used to display the virtual world 110 and various other aspects of the game, such as player position 122 and the locations of virtual elements 130, virtual items 132, and virtual energy 150 in the virtual world 110. The user interface 200 can also display other information, such as game data information, game communications, player information, client location verification instructions and other information associated with the game. For example, the user interface can display player information 215, such as player name, experience level, and other information. The user interface 200 can include a menu 220 for accessing various game settings and other information associated with the game. The user interface 200 can also include a communications interface 230 that enables communications between the game system and the player, as well as between one or more players of the parallel reality game.

According to aspects of the present disclosure, a player can interact with the parallel reality game by carrying a client device around in the real world. For instance, a player can play the game by accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 200 can include non-visual elements that allow a user to interact with the game. For instance, the game interface can provide audible notifications to the player when the player is approaching a virtual element or object in the game or when an important event happens in the parallel reality game. In some embodiments, a player can control these audible notifications with audio control 240. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. Players may also be able to obtain enhanced “powers” or virtual items that can be used to complete game objectives within the game.

Those of ordinary skill in the art, using the disclosures provided, will appreciate that numerous game interface configurations and underlying functionalities are possible. The present disclosure is not intended to be limited to any one particular configuration unless it is explicitly stated to the contrary.

### Example Location-Based Application System

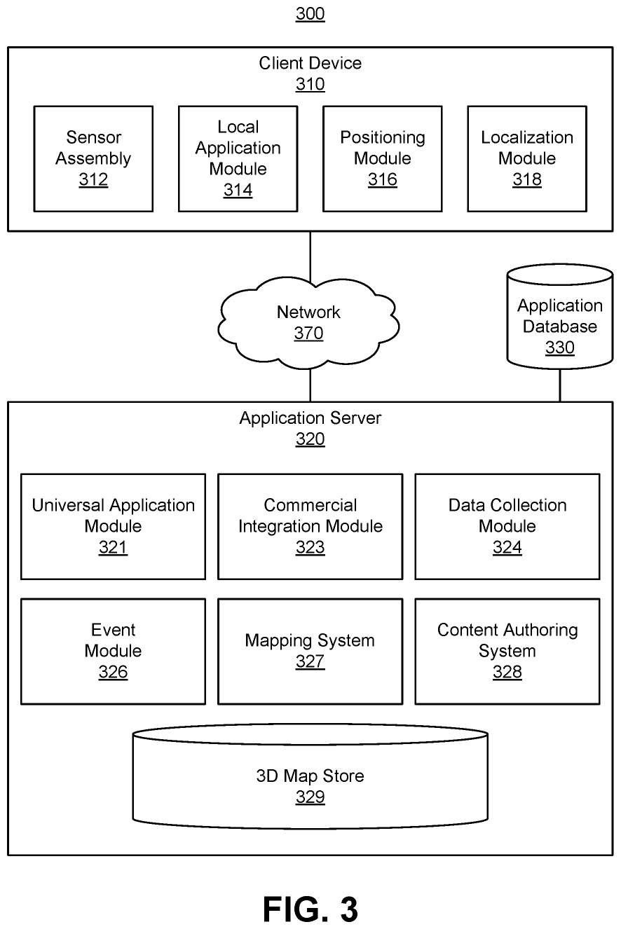

FIG. 3 illustrates one embodiment of a networked computing environment 300. The networked computing environment 300 uses a client-server architecture, where an application server 320 communicates with a client device 310 over a network 370 to provide a location-based application (e.g., a parallel reality game) to a user at the client device 310. The networked computing environment 300 also may include other external systems such as sponsor/advertiser systems or business systems. Although only one client device 310 is shown in FIG. 3, any number of client devices 310 or other external systems may be connected to the application server 320 over the network 370. Furthermore, the networked computing environment 300 may contain different or additional elements and functionality may be distributed between the client device 310 and the application server 320 in different manners than described below.

The networked computing environment 300 provides for the interaction of users in a virtual world having a geography that parallels the real world. In particular, a geographic area in the real world can be linked or mapped directly to a corresponding area in the virtual world. A player can move about in the virtual world by moving to various geographic locations in the real world. For instance, a user's position in the real world can be tracked and used to update the user's position in the virtual world. Typically, the user's position in the real world is determined by finding the location of a client device 310 through which the user is interacting with the virtual world and assuming the player is at the same (or approximately the same) location. For example, in various embodiments, the user may interact with a virtual element if the user's location in the real world is within a threshold distance (e.g., ten meters, twenty meters, etc.) of the real-world location that corresponds to the virtual location of the virtual element in the virtual world. For convenience, various embodiments are described with reference to “the user's location” but one of skill in the art will appreciate that such references may refer to the location of the user's client device 310.

A client device 310 can be any portable computing device capable for use by a user to interface with the application server 320. For instance, a client device 310 is preferably a portable wireless device that can be carried by a user, such as a smartphone, portable gaming device, augmented reality (AR) headset, cellular phone, tablet, personal digital assistant (PDA), navigation system, handheld GPS system, or other such device. For some use cases, the client device 310 may be a less-mobile device such as a desktop or a laptop computer. Furthermore, the client device 310 may be a vehicle with a built-in computing device.

The client device 310 communicates with the application server 320 to provide sensory data of a physical environment. In one embodiment, the client device 310 includes a sensor assembly 312, a local application module 314, a positioning module 316, and a localization module 318. The client device 310 also includes a network interface (not shown) for providing communications over the network 370. In various embodiments, the client device 310 may include different or additional components, such as additional sensors, display, and software modules, etc.

The sensor assembly 312 includes one or more sensors that can capture sensor data describing an environment surrounding the client device 310. In one embodiment, the sensors include one or more cameras which can capture image data. The cameras capture image data describing a scene of the environment surrounding the client device 310 with a particular pose (the location and orientation of the camera within the environment). Cameras may use a variety of photo sensors with varying color capture ranges and varying capture rates. Similarly, the sensor assembly 312 may include cameras with a range of different lenses, such as a wide-angle lens or a telephoto lens. The cameras may be configured to capture single images or multiple images as frames of a video.

The sensor assembly 312 may also include additional sensors for collecting data regarding the environment surrounding the client device 310, such as movement sensors, LIDAR sensors, accelerometers, gyroscopes, barometers, thermometers, light sensors, microphones, etc. The image data captured by the camera assembly 312 can be appended with metadata describing other information about the image data, such as additional sensory data (e.g., temperature, brightness of environment, air pressure, location, pose, depth maps, etc.) or capture data (e.g., exposure length, shutter speed, focal length, capture time, etc.).

The local application module 314 provides a user with an interface to participate in the location-based application (e.g., a parallel-reality game). The application server 320 transmits application data over the network 370 to the client device 310 for use by the local application module 314 to provide a local version of the application to a user at locations remote from the application server. In one embodiment, the local application module 314 presents a user interface on a display of the client device 310 that depicts a virtual world (e.g., renders imagery of the virtual world) and allows a user to interact with the virtual world to perform various objectives (e.g., game objectives). In some embodiments, the local application module 314 presents images of the real world (e.g., captured by the sensor assembly 312) augmented with virtual elements from a virtual world of the application (e.g., game elements for a parallel reality game). In these embodiments, the local application module 314 may generate or adjust virtual content according to other information received from other components of the client device 310. For example, the local application module 314 may adjust a virtual object to be displayed on the user interface according to a depth map of the scene captured in the image data.

The local application module 314 can also control various other outputs to allow a user to interact with the application without requiring the user to view a display screen. For instance, the local application module 314 can control various audio, vibratory, or other notifications that allow the user to be aware of events in the application without looking at the display screen. The local application module 314 may also provide options for the user to interact with the application without looking at the display screen, such as via verbal commands or physical gestures captured by one or more cameras of the sensor assembly 312 (or a separate motion capture device).

The positioning module 316 can be any device or circuitry for determining the position of the client device 310. For example, the positioning module 316 can determine actual or relative position by using a satellite navigation positioning system (e.g., a GPS system, a Galileo positioning system, the Global Navigation satellite system (GLONASS), the BeiDou Satellite Navigation and Positioning system), an inertial navigation system, a dead reckoning system, IP address analysis, triangulation and/or proximity to cellular towers or Wi-Fi hotspots, or other suitable techniques.

As the user moves around with the client device 310 in the real world, the positioning module 316 tracks the position of the user and provides the player position information to the local application module 314. The local application module 314 updates the user position in the virtual world associated with the application based on the actual position of the user in the real world. Thus, a user can interact with the virtual world simply by carrying or transporting the client device 310 in the real world. In particular, the location of the user in the virtual world can correspond to the location of the user in the real world. The local application module 314 can provide user position information to the application server 320 over the network 370. In response, the application server 320 may enact various techniques to verify the location of the client device 310 (e.g., to prevent cheaters from spoofing their locations in embodiments where the application is a location-based game). It should be understood that location information associated with a user is used only if permission is granted after the user has been notified that location information of the user is to be accessed and how the location information is to be utilized in the context of the application (e.g., to update player position in the virtual world). In addition, any location information associated with users is stored and maintained in a manner to protect user privacy.

The localization module 318 provides an additional or alternative way to determine the location of the client device 310. In one embodiment, the localization module 318 receives a coarse location determined for the client device 310 by the positioning module 316 (e.g., GPS coordinates) and refines it by determining a pose of one or more cameras of the sensor assembly 312. The localization module 318 may use the coarse location generated by the positioning module 316 to select a 3D map of the environment surrounding the client device 310 and localize against the 3D map. The localization module 318 may obtain the 3D map from local storage or from the application server 320. The 3D map may be a point cloud, mesh, or any other suitable 3D representation of the environment surrounding the client device 310. Alternatively, the localization module 318 may determine a location or pose of the client device 310 without reference to a coarse location (such as one provided by a GPS system), such as by determining the relative location of the client device 310 to another device.

In one embodiment, the localization module 318 applies a trained model to determine the pose of images captured by a camera assembly relative to the 3D map. Thus, the localization model can determine an accurate (e.g., to within a few centimeters and degrees) determination of the position and orientation of the client device 310. The position of the client device 310 can then be tracked over time using dead reckoning based on sensor readings, periodic re-localization, or a combination of both. Having an accurate pose for the client device 310 may enable the local application module 314 to present virtual content overlaid on images of the real world (e.g., by displaying virtual elements in conjunction with a real-time feed from the camera on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly.

The application server 320 includes one or more computing devices that provide application functionality to the client device 310. The application server 320 can include or be in communication with an application database 330. The application database 330 stores application data used in the location-based application to be served or provided to the client device 310 over the network 370.

In one embodiment, the application data stored in the application database 330 can include: (1) data associated with the virtual world (e.g., image data used to render the virtual world on a display device, geographic coordinates of locations in the virtual world, etc.); (2) data associated with users of the location-based application (e.g., user profiles including but not limited to user information, user experience level, user currency, current user positions in the virtual world/real world, user energy level in a game, user preferences, team information, faction information, etc.); (3) data associated with game objectives (e.g., data associated with current game objectives, status of game objectives, past game objectives, future game objectives, desired game objectives, etc.); (4) data associated with virtual elements in the virtual world (e.g., positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g., location of real-world objects/landmarks, description of real-world objects/landmarks, relevance of virtual elements linked to real-world objects, etc.); (6) game or other application status (e.g., current number of players, current status of game objectives, player leaderboard, etc.); (7) data associated with user actions/input (e.g., current user positions, past user positions, user moves, user input, user queries, user communications, etc.); or (8) any other data used, related to, or obtained during implementation of the location-based application. The application data stored in the application database 330 can be populated either offline or in real time by system administrators or by data received from users (e.g., players), such as from a client device 310 over the network 370.

In one embodiment, the application server 320 is configured to receive requests for application data from a client device 310 (for instance via remote procedure calls (RPCs)) and to respond to those requests via the network 370. The application server 320 can encode application data in one or more data files and provide the data files to the client device 310. In addition, the application server 320 can be configured to receive application data (e.g., user positions, user actions, user input, etc.) from a client device 310 via the network 370. The client device 310 can be configured to periodically send user input and other updates to the application server 320, which the application server uses to update application data in the application database 330 to reflect any and all changed conditions for the application.

In the embodiment shown in FIG. 3, the application server 320 includes a universal application module 321, a commercial integration module 323, a data collection module 324, an event module 326, a mapping system 327, a content authoring system 328, and a 3D map store 329. As mentioned above, the application server 320 interacts with an application database 330 that may be part of the application server or accessed remotely (e.g., the game database 330 may be a distributed database accessed via the network 370). In other embodiments, the application server 320 contains different or additional elements. In addition, the functions may be distributed among the elements in a different manner than described.

The universal application module 321 hosts an instance of the location-based application (e.g., a parallel-reality game) for a set of users (e.g., all users of the application) and acts as the authoritative source for the current status of the application for the set of users. As the host, the universal application module 321 generates application content for presentation to users (e.g., via their respective client devices 310). The universal application module 321 may access the application database 330 to retrieve or store application data when hosting the location-based application. The universal application module 321 may also receive application data from client devices 310 (e.g., depth information, user input, user position, user actions, landmark information, etc.) and incorporates the application data received into the overall location-based application for the entire set of users of the location-based application. The universal application module 321 can also manage the delivery of application data to the client device 310 over the network 370. In some embodiments, the universal application module 321 also governs security aspects of the interaction of the client device 310 with the location-based application, such as securing connections between the client device and the application server 320, establishing connections between various client devices, or verifying the location of the various client devices (e.g., to prevent players cheating by spoofing their location in a parallel-reality game).

The commercial integration module 323, if included, can manage the inclusion of various features within the location-based application that are linked with a commercial activity in the real world. For instance, the commercial integration module 323 can receive requests from external systems such as sponsors/advertisers, businesses, or other entities over the network 370 to include application features. The commercial integration module 323 can then arrange for the inclusion of these application features in the location-based application on confirming that the linked commercial activity has occurred. For example, if a business pays the provider of a parallel-reality game an agreed upon amount, a virtual object identifying the business may appear in the parallel-reality game at a virtual location corresponding to a real-world location of the business (e.g., a store or restaurant).

The data collection module 324 can manage the inclusion of various application features within the location-based application that are linked with a data collection activity in the real world. For instance, the data collection module 324 can modify application data stored in the application database 330 to include application features linked with data collection activity in a parallel-reality game. The data collection module 324 can also analyze data collected by users pursuant to the data collection activity and provide the data for access by various platforms.

The event module 326 manages user access to events in the location-based application. Although the term “event” is used for convenience, it should be appreciated that this term need not refer to a specific event at a specific location or time. Rather, it may refer to any provision of access-controlled application content where one or more access criteria are used to determine whether users may access that content. For example, such content may be part of a larger parallel-reality game that includes game content with less or no access control or may be a stand-alone, access controlled parallel reality game.

The mapping system 327 generates a 3D map of a geographical region based on a set of images. The 3D map may be a point cloud, polygon mesh, or any other suitable representation of the 3D geometry of the geographical region. The 3D map may include semantic labels providing additional contextual information, such as identifying objects tables, chairs, clocks, lampposts, trees, etc.), materials (concrete, water, brick, grass, etc.), or game properties (e.g., traversable by characters, suitable for certain in-game actions, etc.). In one embodiment, the mapping system 327 stores the 3D map along with any semantic/contextual information in the 3D map store 329. The 3D map may be stored in the 3D map store 329 in conjunction with location information (e.g., GPS coordinates of the center of the 3D map, a ringfence defining the extent of the 3D map, or the like). Thus, the application server 320 can provide the 3D map to client devices 310 that provide location data indicating they are within or near the geographic area covered by the 3D map.

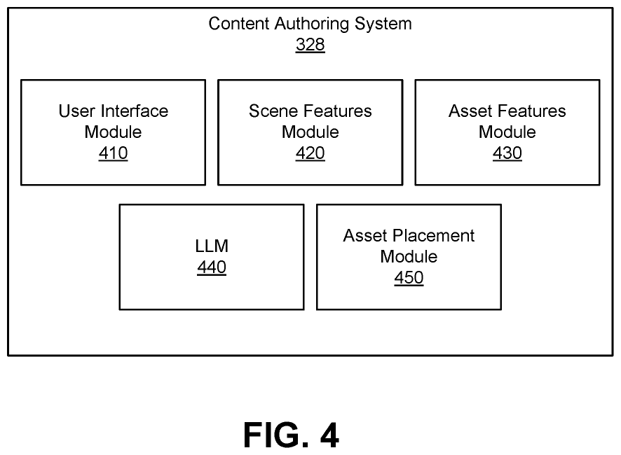

The content authoring system 328 provides a user interface for designers to create virtual experiences. In various embodiments, the content authoring system 328 enables a designer to identify a 3D scene (e.g., a point cloud of a physical location, such as a point of interest), identify a 3D asset, and provide a natural language text prompt indicating where the 3D asset should be placed. The content authoring system 328 applies a model to identify one or more valid placements for the 3D asset. The content authoring system 328 may automatically select a valid placement for the 3D asset or present options to the designer for selection. In this way, the 3D asset can be placed in the 3D scene in accordance with the designer's requirements, and the combination of the positioned 3D asset and 3D scene may be stored as an interactive virtual experience (e.g., in the application database 330). Although the asset is referred to as being placed in the 3D scene for convenience and ease of explanation of the relevant concepts, it should be understood that this does not require amendment of the 3D scene directly. Rather, the 3D scene may be amended or position data for the asset may be stored indicating that the asset has or should be placed at a position relative to a coordinate system of the 3D scene. Users may then experience the virtual experience including the positioned 3D asset (e.g., as part of an AR experience when visiting the physical location or as part of an entirely virtual experience simulating user presence at the location). Various embodiments of the content authoring system 328 are described in greater detail below with reference to FIG. 4.

Although FIG. 3 depicts a content authoring system 328 that resides on the application server 320 that creates virtual experiences, in some embodiments, the same or similar technique may be used by software executing locally on a robot or on a computing system in communication with the robot to enable the robot to implement instructions to place 3D assets (e.g., tangible objects) at locations in a physical space that meet user-specified criteria. For example, the machine-learning components such as the LLM 440 may remain on a remote server to perform more intensive processing, while modules such as the asset placement module 450 may operate directly on the robot to interpret placement results and control movement. In some embodiments, the application server 320 generates recommended positions for tangible objects in response to user commands (e.g., put my shoes under the table), and a robot receives corresponding placement data or motion commands, enabling the robot to navigate to a location near where the object is to be placed and place the object accordingly.

The network 370 can be any type of communications network, such as a local area network (e.g., an intranet), wide area network (e.g., the internet), or some combination thereof. The network can also include a direct connection between a client device 310 and the application server 320. In general, communication between the application server 320 and a client device 310 can be carried via a network interface using any type of wired or wireless connection, using a variety of communication protocols (e.g., TCP/IP, HTTP, SMTP, FTP), encodings or formats (e.g., HTML, XML, JSON), or protection schemes (e.g., VPN, secure HTTP, SSL).

FIG. 4 illustrates one embodiment of the content authoring system 328. In the embodiment shown, the content authoring system 328 includes a user interface module 410, a scene features module 420, an asset features module 430, an LLM 440, and an asset placement module 450. In other embodiments, the content authoring system 328 includes different or additional elements. Furthermore, the functionality may be distributed between components differently than described.

The user interface module 410 provides a user interface via which a designer can provide requirements for a virtual experience. In one embodiment, the designer opens or creates an interactive experience by selecting a 3D representation of a scene (e.g., a point cloud of a physical or virtual location). The designer identifies a 3D asset to be placed in the scene and provides a natural language prompt indicating one or more requirements for positioning of the 3D asset in the scene. For example, the designer might enter “place the asset between the chair and the table, facing the television.” Alternatively, the identification of the 3D asset may be included in the prompt (e.g., place a pair of shoes under the shelf), and the user interface module 410 selects an appropriate 3D asset (e.g., from a library of available 3D assets) based on the prompt. For example, the user interface module 410 may perform a syntactic or semantic analysis to identify one or more keywords describing the desired asset in the prompt and queries an asset library using the keywords, returning one or more assets that are tagged or otherwise associated with at least one of the keywords. If the user interface module 410 cannot identify a suitable 3D asset from the prompt (e.g., if a search identifies multiple possible assets or no suitable assets), the user interface module 410 may ask the designer to clarify, present a list of available assets for the designer to select from, or use any other suitable approach to determine the designer's intent. The terms “asset” and “3D asset” may represent both virtual and real objects. The terms “virtual element” and “virtual object” may be used interchangeably. Similarly, the term “3D scene” may also be referred to as a “3D map” or “virtual environment representation.” The 3D scene may represent a virtual or real location (e.g., a point cloud of a virtual or a real room).

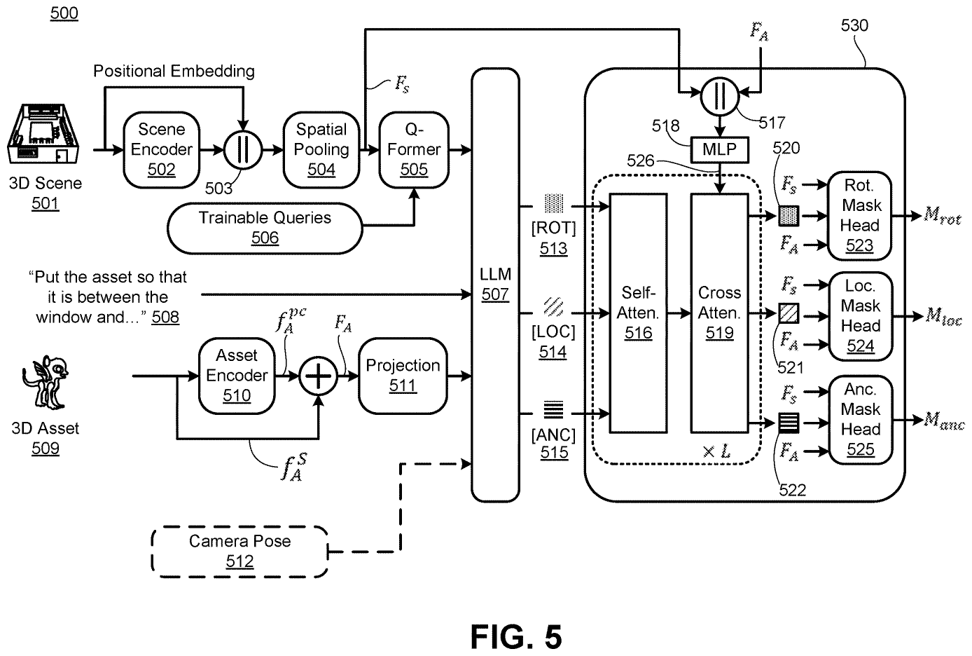

The scene features module 420 generates a vector representing the scene that is suitable for input to the LLM 440. In one embodiment, the scene features module 420 takes a 3D representation of the scene (e.g., a point cloud) as input and applies a point encoder to extract features from the 3D representation. The features may be complemented with positional embeddings and spatial pooling applied to reduce the feature dimensions. The scene features module 420 may use a Q-Former to merge the pooled features with trainable queries. The vector representing the scene may be referred to as a “scene vector.” The features extracted by the scene features module 420 may collectively be referred to as “scene features.” Functions of the scene features module 420 are described further with respect to FIG. 5.

The asset features module 430 generates a vector representing the 3D asset that is suitable for input to the LLM 440. In one embodiment, the asset features module 430 encodes the 3D asset into a single vector using a pretrained asset encoder followed by max-pooling. The asset features module 430 may combine (e.g., concatenate) the generated single vector with a size embedding and pass the combined vector to a projection layer that aligns the features with the LLM space. The resulting vector aligned with the LLM space may be referred to as an “asset vector.” The combined output of the generated single vector with the size embedding may also be referred to as a “combined asset feature.” Functions of the asset features module 430 are described further with respect to FIG. 5.

The LLM 440 takes as input the vectors generated by the scene features module 420 and the asset features module 430 as well as the prompt provided by the designer to generate one or more tokens relevant to the determination of a recommended position or positions for the 3D asset. In one embodiment, the LLM 440 generates three tokens: a location token that includes features the LLM 440 determines to be relevant to identifying valid locations for the 3D asset, a rotation token that includes features that the LLM 440 determines are relevant to identifying valid orientations of the 3D asset, and an anchor token that includes features the LLM 440 determines are relevant to identifying anchor objects in the 3D scene (e.g., those identified in the prompt) that are relevant to the location and orientation of the 3D asset. The term “token” may correspond to a data representation (e.g., feature embedding) generated by the LLM 440 for a specific placement task element. The tokens output by the LLM 440 (e.g., a location token, rotation token, and anchor token) may be referred to collectively as placement tokens. The LLM 440 is described further with respect to FIG. 5.

The asset placement module 450 receives the tokens generated by the LLM 440 as input and identifies one or more recommended positions for the 3D asset. In various embodiments, the asset placement module 450 applies a transformer-based decoder that takes as input the features associated with the tokens generated by the LLM 440 and the pooled scene features and performs self and cross attention operations. One or more prediction heads are included in the decoder to generate one or more masks. The term “prediction head” may also be referred to as a “mask head.” Each mask head may produce a respective mask, such as the location mask, rotation mask, or anchor mask. In one specific embodiment, three prediction heads are used to generate three masks: a location masks indicating valid locations in the 3D scene for the 3D asset, a rotations masks that indicates valid orientations of the 3D asset at each valid location, and an auxiliary mask that indicates the location(s) of anchor objects used in determining the valid locations and orientations (i.e., the objects identified in the prompt that place imitations of the positioning of the 3D asset).

The asset placement module 450 provides the one or more recommended positions for display to the designer in the user interface. In one embodiment, the asset placement module 450 provides the masks to the user interface to be overlaid on a view of the 3D scene presented to the designer. In this way, the designer can quickly see possible positions (e.g., locations and orientations) for the asset that are consistent with the prompt and select one. Alternatively, the asset placement module 450 may select a recommended position and display the 3D asset at that position in the view of the 3D scene for the designer to approve or modify. For example, the asset placement module 450 may randomly select a location and orientation from the possible orientations and locations indicated by the masks. Alternatively, the location and orientation may be selected from the possible locations and orientations using one or more metrics, such as proximity to other assets, likelihood of being a “good” position (e.g., based on positions selected for similar assets by designers previously), and the like. The metrics are described further with respect to FIG. 5.

### Example Machine Learning Architecture for Object Placement

FIG. 5 illustrates a machine learning architecture 500 for object placement, according to at least some embodiments. The architecture 500 shows the overall data flow for language-guided three-dimensional (3D) object placement. FIG. 5 provides a detailed process of how the content authoring system 328 may execute machine-learning operations to process a 3D scene 501, a 3D asset 509, and a natural-language prompt 508 to determine valid placement positions for the 3D asset 509 within a location represented by the 3D scene 501 according to the natural-language prompt 508. The architecture depicted in FIG. 5 may be implemented in whole or in part by one or more modules of the content authoring system 328 depicted in FIG. 4, such as the scene features module 420, the asset features module 430, the LLM 440, and the asset placement module 450, operating together or in various combinations. Thus, FIG. 5 expands upon the framework of FIG. 4 by illustrating how those modules interact as functional components of an end-to-end workflow for generating recommended 3D asset placements.

The content authoring system 328 may receive the 3D scene 501, the natural-language prompt 508, and the 3D asset 509 as inputs, directly or indirectly (i.e., with additional pre-processing), to an LLM 507. The 3D scene 501 may be represented as a point cloud, polygonal mesh, depth map, or other 3D representation of an environment. The 3D asset 509 may also be represented as a point cloud or mesh describing the geometry and appearance of the object to be placed in the 3D scene 501. The placement of an object within a 3D scene may refer to the placement of a real object in a physical environment represented by the 3D scene or the placement of a virtual object in a virtual environment represented by the 3D scene. A designer may further provide a natural-language prompt 508 describing one or more placement requirements (e.g., relative position, visibility, or orientation) of the 3D asset 509 within the 3D scene 501. In some embodiments, the LLM 507 also receives a camera pose 512 as input data. The camera pose 512 may include data describing the position and orientation of a camera that captured the 3D scene 501 or that defines a viewpoint from which placement is to be evaluated. Although not depicted, additional optional inputs to the LLM 507 may include semantic tags identifying objects or surfaces within the 3D scene, physical measurements (e.g., lighting direction or surface material properties), environmental metadata such as room type or usage context, user profile data (e.g., accessibility parameters or aesthetic preferences), external sensor readings (e.g., thermal or depth information), or a combination thereof. In some embodiments, the architecture 500 ingests contextual information from temporal data (e.g., changes in the scene over time) or external databases describing canonical object relationships within particular environments. Diverse inputs collectively allow the content authoring system 328 to reason jointly over scene geometry, asset characteristics, and linguistic constraints when generating placement outputs.

The machine-learning architecture 500 may include a scene encoding subsystem configured to transform a 3D representation of a scene (e.g., a point cloud) into an embedding aligned for an LLM space. In the example depicted in FIG. 5, the scene encoding subsystem may include a scene encoder 502, a concatenator 503, a spatial pooling module 504, and a Q-Former 505. The scene encoding process may begin by applying the scene encoder 502 that extracts geometric, color, surface, and/or semantic features from the 3D scene 501. In some embodiments, the content authoring system 328 may represent the 3D scene 501 as a point cloud X∈ [symbol] N×6, where each point includes three spatial coordinates (x, y, z) and three color values (R, G, B). The scene encoder 502 may employ point-based neural network architectures (e.g., multi-layer perceptrons (MLPs) or transformer blocks) that process these point-wise features.

The content authoring system 328 may combine the extracted features of the point cloud representing the 3D scene with positional embedding features that encode absolute or relative spatial coordinates for each point of the point cloud. This combination may be referred to as “combined point-wise features.” A concatenator 503 may be used to combine the extracted features with the positional embedding features. The positional embedding features may link each point's features to its specific coordinates within the 3D scene 501, so that the content authoring system 328 maintains awareness of where surfaces and objects are located while reasoning about possible placement locations. In some embodiments, the scene features module 420 may determine the positional embedding features using sinusoidal or hierarchical position encoding functions. The positional embedding features and point-wise features may then be concatenated or otherwise combined to produce combined point-wise features. The combined point-wise features may jointly expresses geometry, color, and spatial position for each point in the 3D scene 501.

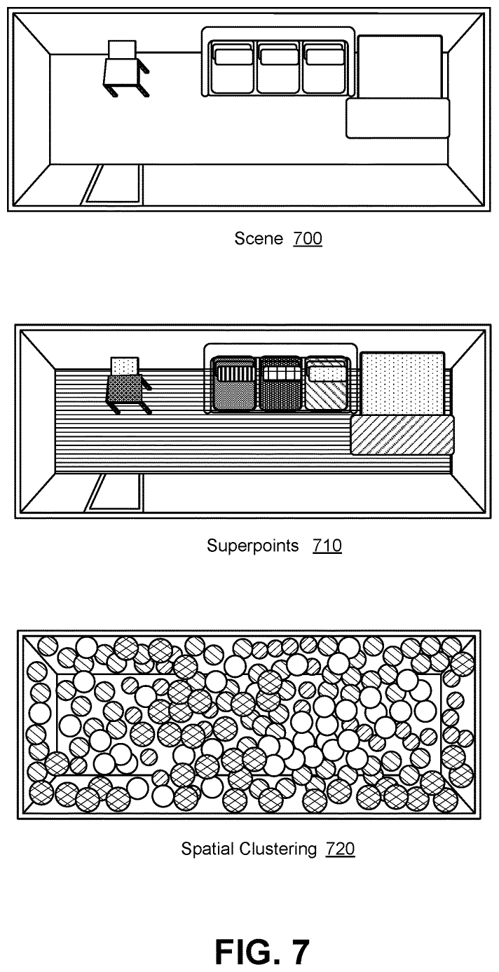

In some embodiments, the content authoring system 328 may implement a spatial pooling module 504. The spatial pooling module 504 may be advantageous to reduce computational cost while preserving local spatial context. The spatial pooling module 504 may partition a full point cloud into smaller subregions centered around representative points, which may be referred to as center points. The center points may be selected using farthest-point sampling. Farthest-point sampling may include iteratively selecting points that are farthest away from previously selected points, which may result in an even distribution of center points selected throughout the 3D scene 501. Each remaining point in the 3D scene 501 may then be assigned to its nearest center point (e.g., based on Euclidean distance), forming nested regions of points around each center. Within each region, the content authoring system 328 may apply pooling operations (e.g., mean-pooling, max-pooling, or learned attention-based pooling) to aggregate the features of points assigned to the region, producing region-wise features F_{S} that summarize local geometry within each neighborhood. Spatial pooling is further described with respect to FIG. 7. In some embodiments, when processing resources are sufficient, the content authoring system 328 may bypass pooling altogether and process every point feature directly, allowing for maximal precision at the expense of memory and latency. Although F_{S} is depicted in FIG. 5 as output from the spatial pooling module 504, in embodiments where the spatial pooling module 504 is omitted, F_{S} may be combined point-wise features output from the concatenator 503.

The region-wise features F_{S} may then be provided as input to a Q-Former 505, together with one or more trainable queries 506, to align the features F_{S} with an embedding space of a language model. The Q-Former 505 may act as an intermediary module that learns to focus on portions of the 3D scene 501 most relevant for interpreting the natural-language prompt 508. In this configuration, each trainable query 506 may interact with the features F_{S} through attention to extract information that is most relevant to spatial and semantic reasoning. For example, the Q-Former 505 may compute an attention score between every query and every scene feature, and features receiving higher attention scores may contribute more to the query's output embedding while those with lower scores contribute less. The resulting output embeddings may describe key geometric structures and contextual elements of the 3D scene 501 in a form suitable for processing by stages of the LLM 507. For example, one query may learn to emphasize the horizontal surfaces within the 3D scene 501 that are suitable for supporting objects, while another may capture vertical structures likely to serve as walls or partitions. In this way, the Q-Former 505 may bridge a 3D numerical representation of a scene and semantics of a natural-language prompt.

In addition to a scene encoding subsystem, the machine-learning architecture 500 may also include an asset encoding subsystem. The asset encoding subsystem may include an asset encoder 510, an adder, and a projection module 511. The asset features module 430 of the content authoring system 328 may execute operations of the asset encoding subsystem. For example, the asset features module 430 may apply the asset encoder 510 to process the 3D asset 509 and generate point-wise feature representations that describe both geometry and appearance. The 3D asset 509 may be represented as a colored point cloud, such that each point includes three spatial coordinates and three color values, producing a feature space of dimension N× 6. The asset encoder 510 may extract point-wise asset features from points of the 3D point cloud (e.g., using a Point-BERT encoder). The asset encoder 510 may predict a sequence of feature vectors that are max-pooled to obtain a single feature embedding. The output of the asset encoder 510 is represented as

$${f}_{A}^{pc} .$$

In some embodiments, the content authoring system 328 may extract a size embedding

$${f}_{A}^{S}$$

that encodes the object's physical dimensions or other size-related metrics so that scaling effects are captured (e.g., even when the input asset is normalized before encoding). The point-wise asset features or the single feature embedding may be combined with the size embedding

$$( i . e . , {f}_{A}^{pc} combined with {f}_{A}^{S} ) .$$

The content authoring system 328 may perform this combination using concatenation or as depicted in FIG. 5, summation (e.g., weighted summation) to form a combined asset feature F_{A} conveying both geometric and size attributes of the 3D asset 509. The combined asset feature F_{A} may then pass through a projection module 511, which may project or map the feature embedding into a common embedding space of the LLM 507. The resulting asset vector output from the projection module 511 is aligned to the LLM's multimodal feature space.

The LLM 507 may receive as inputs a scene vector output from the Q-Former 505, an asset vector output from the projection module 511, and the natural-language prompt 508 describing placement requirements. The LLM 507 may interpret relationships among these inputs to determine relationships between natural language instructions and geometric configurations within the 3D scene 501 for placing the 3D asset 509. As part of this process, the LLM 507 may output multiple tokens: a rotation [ROT] token 513 representing rotation-related features, a location [LOC] token 514 representing location-related features, and an anchor [ANC] token 515 representing anchor-related features identified from contextual analysis of the prompt. In some embodiments, the LLM 507 may update its internal embeddings through attention mechanisms that align textual representations from the natural-language prompt 508 with visual-spatial representations derived from the 3D scene 501 and 3D asset 509. In this way, the LLM 507 may produce a unified spatial-semantic representation that interrelates language, geometry, and object context, preparing intermediate embeddings and tokens for a decoding stage that predicts valid placement regions and orientations.

In some embodiments, the content authoring system 328 may apply a combination of loss functions to train the LLM 507 of the machine-learning architecture 500. The loss functions may quantify the difference between a set of predicted masks and corresponding ground-truth masks, where each ground-truth mask encodes the valid placements and orientations of the 3D asset 509 within the 3D scene 501. The content authoring system 328 may employ both a Binary Cross-Entropy (BCE) loss and a Dice loss to provide complementary optimization signals for segmentation accuracy. The combined segmentation loss may be expressed as:

$${L}_{seg} ( \overline{M} , M ) = BCE ( \overline{M} , M ) + Dice ( \overline{M} , M )$$

where M̅ denotes a ground-truth mask and M denotes a corresponding predicted mask.

In some embodiments, the content authoring system 328 may separately compute a rotation loss that measures prediction quality for the set of valid rotation angles applicable to each spatial location in the 3D scene. This rotation loss may also employ the Binary Cross-Entropy formulation and may be defined as:

$${L}_{rot} = BCE ( {\overline{M}}_{rot} , {M}_{rot} )$$

where M̅ᵣₒₜ∈{0,1}^{N×8} represents a ground-truth indicator mask specifying valid rotation angles (e.g., discretized yaw orientations) for each of the N points in the 3D scene point cloud, and Mᵣₒₜ represents the corresponding predicted rotation mask.

In addition to the spatial and rotational components, the content authoring system 328 may apply a language-alignment loss to train the LLM 507 to generate appropriate token outputs in response to each prompt. This loss, denoted L_{L}, may be a cross-entropy (CE) loss that compares the predicted textual response Y with the reference or ground-truth text Y̅:

$${L}_{L} = CE ( \overline{Y} , Y )$$

For training efficiency, the reference text Y̅ may follow a simplified fixed format (e.g., a short confirmation string “Sure, it is [LOC], [ANC], and [ROT]”). The semantic and spatial information learned for placement prediction may be encoded instead in the embeddings associated with these special tokens.

In some embodiments, the content authoring system 328 may compute a total composite loss that combines each of the individual terms used during training. This total loss may be expressed as:

$$L = {L}_{seg} ( {\overline{M}}_{loc} , {M}_{loc} ) + {L}_{rot} + {L}_{seg} ( {\overline{M}}_{anc} , {M}_{anc} ) + {L}_{L}$$

Here, M̅_{loc} and M_{loc} correspond to the ground truth and predicted location masks, and M̅_{anc} and M_{anc} represent the ground truth and predicted anchor masks. In some embodiments, these combined terms may guide the LLM 507 to optimize placement quality across locations, rotational angles, and requirements specified by a natural-language prompt.

A decoding stage 530 may follow the LLM 507 to determine placement predictions for the 3D asset 509 using the tokens 513-515 output by the LLM 507. The asset placement module 450 of the content authoring system 328 may perform operations of the decoding stage 530. The decoding stage may include one or more self-attention layers 516, a concatenator 517, an MLP 518, one or more cross-attention layers 519, a rotation mask head 523, a location mask head 524, and an anchor mask head 525. The decoding stage 530 may receive the tokens 513-515 produced by the LLM 507 and apply one or more self-attention layers 516 operations to refine interactions among these tokens. The one or more self-attention layers 516 may output updated tokens representing interactions among the tokens output by the LLM 507. Following the self-attention layer(s) 516, the decoding stage 530 may apply the one or more cross-attention layers 519 that combine the updated tokens with an output feature 526, where the output feature 526 is determined using features F_{S} and F_{A}. In particular, the features F_{S} and F_{A} may be combined (e.g., using the concatenator 517) and the combined feature may be input into an MLP 518. The MLP may transform the combined feature to produce the output feature 526. The decoding stage 530 uses the cross-attention between the one or more updated tokens and the output feature 526 to generate one or more context-enhanced token features (e.g., a rotation token feature 520, a location token feature 521, and an anchor token feature 522).

Multiple mask heads 523-525 may determine respective prediction masks from the attended features. A rotation mask head 523 may produce a rotation mask Mᵣₒₜ identifying valid orientation angles for the 3D asset 509 at one or more locations of the 3D scene 501. A location mask head 524 may predict a location mask M_{loc} that assigns likelihood values to each region of the 3D scene 501, indicating potential placement positions consistent with the prompt 508. An anchor mask head 525 may output an anchor mask M_{anc} encompassing masks of anchor objects referenced in the prompt 508. The anchor mask head 525 may be used as an auxiliary task (e.g., used only for training the LLM 507 and not used during inference) to help the LLM 507 identify anchors in input prompts.

In some embodiments, the content authoring system 328 may use the masks output by the architecture 500 to determine one or more recommended placements for a 3D asset within a 3D scene. The rotation mask Mᵣₒₜ may indicate preferred orientations for candidate locations in the 3D scene. The location mask M_{loc} may provide likelihoods or confidence values for the candidate regions in the 3D scene 501. Using these combined predictions, the content authoring system 328 may select one or more placement configurations that satisfy both geometric and linguistic constraints.

During inference, the content authoring system 328 may process model predictions produced for the placement mask M_{loc} and the rotation mask Mᵣₒₜ to extract one or more valid placements of the 3D asset 509 within the 3D scene 501. The system may identify a single valid placement by selecting the point in the point cloud having the highest predicted value in the placement mask, expressed as

$$\hat{x} = {argmax}_{m ∈ {M}_{loc}} m$$

A fixed offset may be applied to the selected point \hat{x}, equal to one-half of the asset height, to determine the predicted 3D translation vector \hat{t}. This offset may account for differences in how the contact point of the asset is represented in training versus benchmark parameterizations. To determine rotation, the system may use the vector

$${M}_{rot}^{\hat{x}} ∈ {[ 0 , 1 ]}^{8}$$

which encodes the validity of discretized rotation angles for the corresponding spatial position x. The predicted rotation angle \hat{α} may be determined by taking the argmax of this rotation-likelihood vector. Accordingly, the content authoring system 328 may compute a complete pose, including both translation and orientation, for the 3D asset 509 in the 3D scene 501 based on the model's inference outputs.

The recommended placements determined using the architecture 500 may be visualized within a graphical user interface (GUI) (e.g., a display at the client device 310), where valid regions are overlaid on a rendering of the 3D scene 501, allowing a designer to preview or confirm the positioning of the 3D asset 509. Alternatively, the recommended placements may be applied automatically to generate virtual content (e.g., by populating augmented- or mixed-reality experiences without further human intervention).

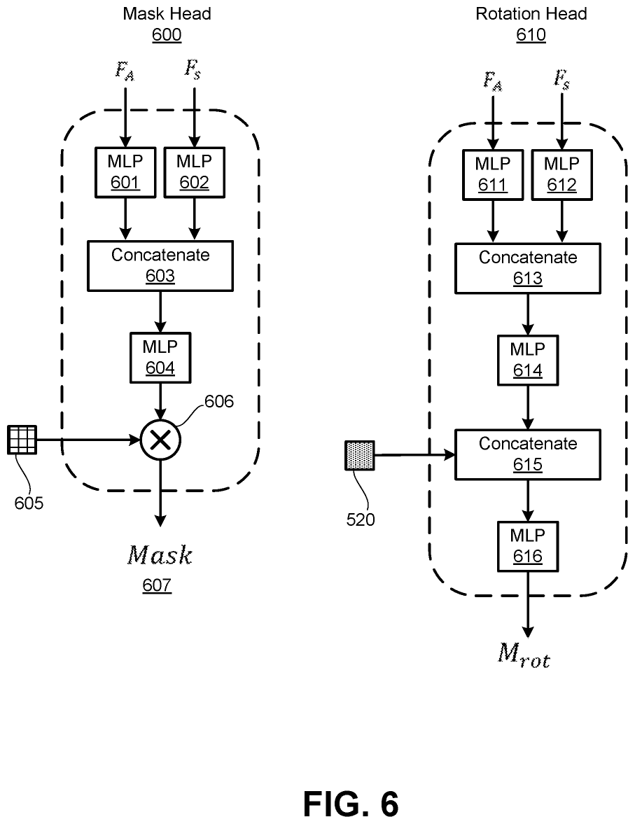

FIG. 6 depicts examples of decoder head architectures that product mask outputs for object placement, in accordance with some embodiments. The decoder heads include a mask head 600 and a rotation head 610. The content authoring system 328 may apply one or more of the depicted decoder heads (e.g., in the decoding stage 530 of FIG. 5). The mask head 600 may represent a location mask head configured to generate a location mask M_{loc} identifying valid regions within a 3D scene (e.g., the 3D scene 501) for placing a 3D asset (e.g., the 3D asset 509). In some embodiments, the same head structure could be used or adapted as an alternative rotation or anchor mask head, depending on the configuration of the decoder. Both heads may operate on multimodal features, including respective token features 605 and 520, together with region-wise features Fₛ (or, when spatial pooling is bypassed, combined point-wise features) and the combined asset feature F_{A}. The token features 605 and 520 may be the output of one or more attention layers downstream of an LLM (e.g., the LLM 507). As shown, each head combines these inputs using MLPs, one or more concatenation operations, and/or feature-combination operations (e.g., gating or weighting) to produce masks providing spatial or rotational guidance for placement prediction.

In some embodiments where the mask head 600 is used to determine a location mask as the mask 607, the mask head 600 may receive the region-wise or combined point-wise scene features Fₛ and the combined asset feature F_{A} as primary inputs and process them respectively through MLPs 601 and 602. The outputs of MLP 601 and 602 may be merged by a concatenator 603, which aligns the feature dimensions to produce a unified embedding that encodes both scene context and asset characterization. This unified embedding may then be refined through the MLP 604, which may perform nonlinear transformations to emphasize the spatial regions of the 3D scene 501 that are compatible with the 3D asset 509. The output of the MLP 604 may subsequently interact with a token feature 605 (e.g., a context-enhanced location token feature) via a multiplicative or gating operation (e.g., element-wise multiplication) at the multiplication unit 606, so that the [LOC] token feature acts as a weighting factor on the spatial feature map derived from the scene and asset. In this way, the token feature 605 may be used to identify a particular placement characteristic (e.g., locations in the 3D scene that correspond to the linguistic placement instructions). The output of the multiplication unit 606 may be a spatial probability distribution output as a mask 607 (e.g., a location mask), identifying likely placement regions within the 3D scene 501 compliant with a natural-language prompt. Accordingly, the mask head 600 may generate a location mask M_{loc} or, in other configurations, serve as a general-purpose prediction head for other scene-related masks.

The rotation head 610 may predict possible orientations of the 3D asset 509 when placed in the 3D scene 501. The rotation head 610 may receive as input the combined asset feature F_{A} and the region-wise or combined point-wise scene features Fₛ. Each input may be processed through respective MLPs 611 and 612 to extract rotation-specific embeddings that capture shape- and surface-orientation relationships. The outputs of MLPs 611 and 612 may then be merged by a concatenator 613 to create a joint representation of asset and scene features. This joint representation may be refined through an MLP 614, which may learn correlations between the shape of the 3D asset 509 and the geometry of nearby scene surfaces to identify valid rotation configurations. The output of the MLP 614 may be further combined through a concatenator 615 with the [ROT] token feature 520, allowing the head 610 to encode natural-language rotational requirements such as “facing the window” or “oriented toward the door.” The output from the concatenator 615 may be processed by a final MLP 616 to generate the rotation mask Mᵣₒₜ, representing discrete angular likelihoods or continuous rotation probabilities for one or more locations for the 3D asset in the 3D scene. In this way, the rotation head 610 may provide per-point orientation guidance corresponding to the 3D asset's valid angles (e.g., yaw angles).

The differing architectures of the mask head 600 and the rotation head 610 can be used to output different prediction masks with different objectives. For example, while the mask head 600 can use the multiplication unit 606 to apply token-driven weighting across spatial embeddings, the rotation head 610 can use concatenation and additional feature fusion to generate higher-dimensional angle predictions. This difference may reflect two different objectives: one objective for lightweight per-point scoring and another suited for complex multidimensional inference. In some embodiments, similar head architectures may be adapted to other purposes. For example, an anchor mask head may implement one of the architectures shown in FIG. 6 to identifying referenced anchor objects (e.g., furniture, walls, or fixtures described in the prompt).

FIG. 7 shows examples of alternative scene-encoding strategies, in accordance with some embodiments. The strategies are represented by a 3D scene 700, a superpoint configuration 710, and a spatial clustering configuration 720. Together, these examples show how different techniques for aggregating points in a 3D scene may enable the content authoring system 328 to trade geometric fidelity (i.e., the preservation of shapes and positions of surfaces and objects) for computational efficiency during the scene-encoding process. The 3D scene 700 may represent a raw, unpooled configuration of the input environment at full resolution. The superpoint configuration 710 and the spatial clustering configuration 720 may show progressively abstracted forms used by the system to reduce memory and processing demands. The illustration provides a visual comparison of how the content authoring system 328 may transition from complete, per-point features to more compact region-wise features (e.g., Fₛ) for machine-learning-based reasoning and mask prediction.

The 3D scene 700 may correspond to a reconstructed real-world environment represented as a dense point cloud. Each point may include geometric and color attributes such as position coordinates (x, y, z) and color values (R, G, B), yielding an N×6 feature matrix. This representation may preserve the highest possible level of detail and thus serve as the basis for generating precise placement predictions. However, processing every point individually may increase computational requirements. Accordingly, alternative feature-aggregation techniques such as superpoints or spatial pooling may be applied. Here, superpoints refers to clusters of adjacent points in a point cloud that share similar geometric or semantic properties, forming coarse regions that collectively represent larger surfaces or objects within the 3D scene. Spatial pooling is also described with respect to FIG. 5. The raw point representation of scene 700 demonstrates the origin of the input features prior to any grouping or dimensionality reduction.

The superpoint configuration 710 may divide the 3D scene 700 into large regions that share similar appearance or surface characteristics. Each region, or “superpoint,” may group together points that belong to the same major surface (e.g., a floor, wall, or tabletop). This approach may reduce the total number of features that the content authoring system 328 needs to process, helping to simplify computation. However, because the regions are broad and may cover large surfaces, the superpoint configuration 710 can lose fine-grained detail. For example, if the floor is represented as a single large superpoint, the system 328 may not distinguish between different areas on that same floor (some locations may be valid for placement while others may not) so the LLM may not learn the fine-grained differences needed for accurate positioning. As a result, superpoints may be less effective for tasks requiring high spatial accuracy, such as positioning smaller objects or placing assets according to natural-language prompts that suggest a smaller area of a surface is valid.

The spatial clustering configuration 720 may represent a scene encoding approach that keeps more detail while remaining efficient to process. Here, the content authoring system 328 may select evenly spaced center points and assign each point in the scene to its nearest center by measuring actual spatial distance. The points linked to a center may form a cluster, also called a region. The system may then combine features from points inside each region (e.g., using max-pooling). This step creates smaller region-wise features Fₛ that can still retain differences between surfaces. For example, separate clusters may exist for the top of a table and for a nearby wall, helping the system 328 distinguish between them when responding to a prompt like “place the asset on the table.” The spatial clustering configuration 720 may thus reduce computation compared to processing every point individually while maintaining accuracy suitable for detailed placement reasoning.

As illustrated in FIG. 7, the content authoring system 328 may use the arrangement shown in spatial clustering configuration 720 as a balance between the detailed but heavy processing of the full scene 700 and the lighter but coarse representation of the superpoints configuration 710. Clustering and pooling may allow the system 328 to operate on compact data without losing essential geometric details. This approach may be especially helpful for lightweight or mobile implementations that run on devices with limited computing hardware. When more computing resources are available, the system may skip pooling and use each point's features directly for maximum precision. In this way, the structures illustrated in FIG. 7 show how different scene-encoding choices may affect both the accuracy and efficiency of the content authoring system 328 when the system 328 predicts placement locations for 3D assets 509.

The design of spatial pooling module 504 may provide an effective trade-off between precision and computational efficiency. Spatial pooling may reduce the number of point-wise features processed while maintaining sufficient geometric fidelity for accurate asset placement, which can be advantageous for lightweight or embedded machine-learning deployments such as mobile phones or wearable headsets. In compute-rich environments, a non-pooled, dense encoding may be used to achieve finer-grained spatial precision when higher processing resources are available. In this way, the architecture 500 illustrated in FIG. 5 may flexibly scale from low-power devices performing efficient inference to high-performance systems supporting detailed 3D reasoning.

### Example Applications

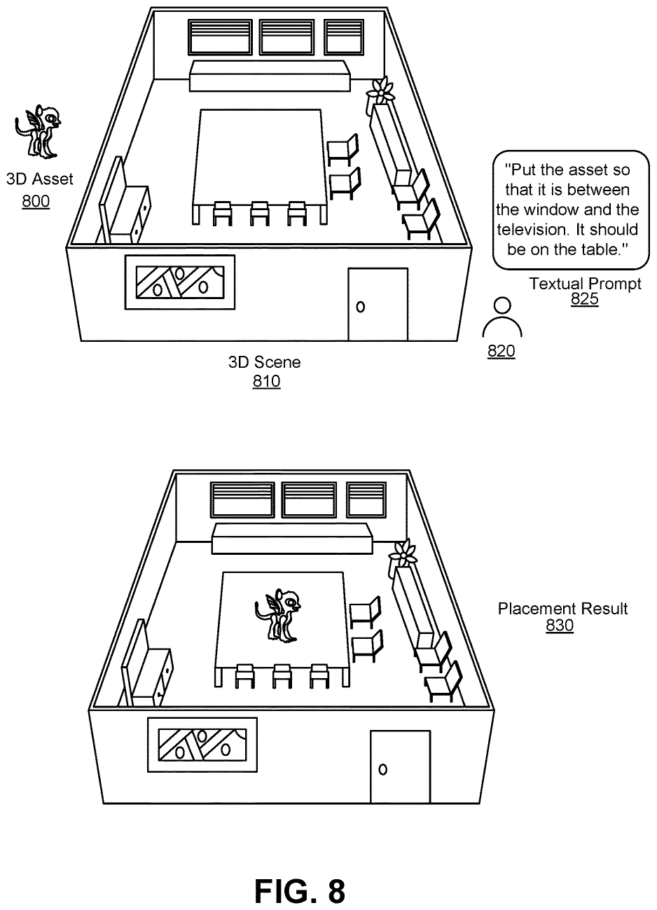

FIG. 8 is a first example application of performing a language-guided placement of a 3D asset within a 3D scene. FIG. 8 shows a 3D asset 800, a 3D scene 810, a user 820 providing a textual prompt 825, and a placement result 830 of the asset (e.g., as determined by the content authoring system 328). The example demonstrates how the system 328 may interpret descriptive phrases from natural language to generate a physically and semantically valid location in a reconstructed real-world environment. As shown, the textual prompt 825 specifies that the asset should be placed “between the window and the television” and “on the table,” introducing both spatial and physical constraints for the model to satisfy. This embodiment provides an illustration of the workflow enabled by the machine-learning architecture 500 described in FIG. 5.

The content authoring system 328 may process the textual prompt 825 (“between the window and the television and on the table”) by applying a trained model (e.g., the LLM 440 or the LLM 507) to infer how the described spatial relationships translate to valid placement regions in the 3D scene 810. The LLM may integrate a learned understanding of anchor relationships into its reasoning when producing a location mask and/or rotation mask. For example, the resulting location mask may indicate locations geometrically consistent with the “between” and “on” constraints. The placement result 830 shows the asset positioned accurately between the window and television, resting on the table, as determined from the LLM's combined geometric and linguistic reasoning.

FIG. 8 demonstrates how the workflow described with respect to FIGS. 4 and 5 enables text-driven design operations without requiring manual adjustments by the user 820. The example shows how the content authoring system 328 interprets ordinary, conversational language and then converts the language into precise placement behavior. Rather than the user 820 manually positioning the 3D asset 800 within a modeling tool, the user 820 may write or say a short natural-language description, and the system 328 may apply the machine-learning architecture described to complete the task. This capability allows creators to author augmented-reality or virtual-reality content using descriptive phrases rather than coordinate data or 3D manipulation interfaces.

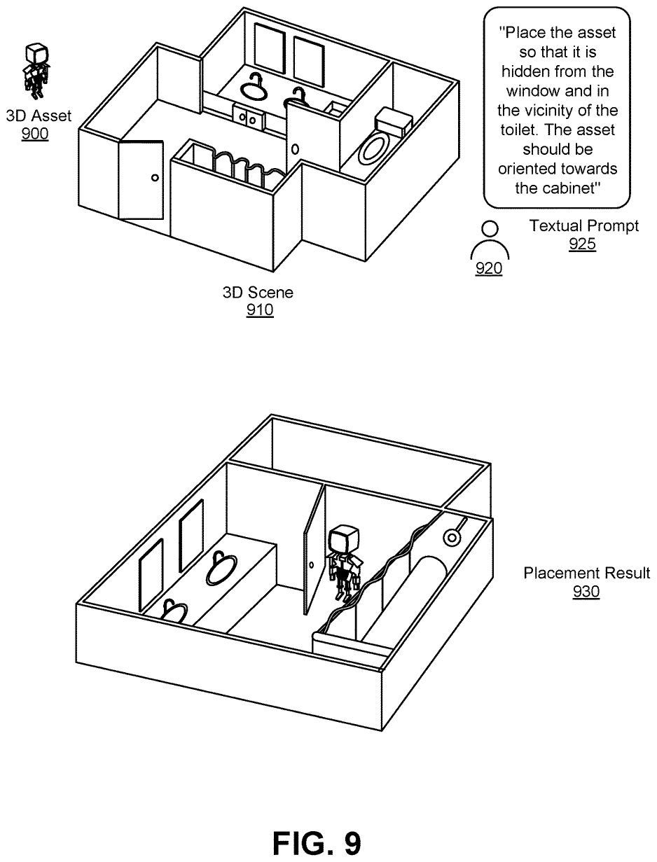

FIG. 9 is a second example of performing natural language-guided placement of a 3D asset. FIG. 9 depicts a 3D asset 900, a 3D scene 910, a user 920 providing a textual prompt 925, and a placement result 930 (e.g., as determined by the content authoring system 328). This example shows how the system 328 interprets instructions that involve relationships between visibility, proximity, and orientation, all present in the prompt “Place the asset so that it is hidden from the window and in the vicinity of the toilet. The asset should be oriented towards the cabinet.” FIG. 9 thus highlights the capability of the machine-learning architecture described to process prompts containing multiple types of constraints simultaneously.

In some embodiments, the content authoring system 328 may parse the textual prompt 925 to identify how each described condition affects possible placements in the 3D scene 910. During training, an LLM may learn how hidden-from, near, and oriented-toward constraints influence the position and rotation of an asset, but during inference no explicit anchor masks may be predicted. Instead, the LLM can apply its internal understanding of these relationships to produce the corresponding location and rotation masks. The location mask may highlight regions that satisfy proximity and visibility constraints (e.g., areas close to the toilet but beyond any direct line of sight from the window) while the rotation mask identifies orientations (e.g., facing the cabinet). The system 328 may then determine a highest-likelihood position and orientation consistent with those inferred constraints. In placement result 930, the 3D asset 900 appears near the toilet, directed toward the cabinet, and hidden from the window, fulfilling every condition in the textual prompt 925.

FIGS. 8 and 9 demonstrate how the architecture shown in FIG. 5 can reason over multiple kinds of spatial instructions to produce context-aware placements across various scene environments. The architecture may be applied in real use cases such as architectural visualization, AR scene setup, or automated layout design, where users may provide general descriptions like “make it near one object but out of sight from another.” In this way, FIGS. 8 and 9 illustrate the flexibility of the content authoring system 328 in performing complex, multi-constraint reasoning from natural-language prompts to generate realistic and semantically accurate placement recommendations.

In some embodiments, the same machine-learning architecture shown in FIG. 5 can be applied in a variety of contexts beyond the examples illustrated in FIGS. 8 and 9. These applications may include interior design, accessibility planning, photography, augmented-reality authoring, or other creative scenarios that benefit from natural-language interfaces. In each case, a user may provide a prompt describing a desired relationship between a 3D asset and its surrounding 3D scene, and the content authoring system 328 may interpret those directions using the same multimodal reasoning process described earlier. The system can thus generate placement recommendations that reflect not only geometric and physical constraints, but also personal preferences, accessibility considerations, or stylistic objectives. The following examples describe how this model may be used in different real-world authoring workflows.

In one example, a user designing a home kitchen may rely on the content authoring system 328 to ensure accessibility while planning the placement of appliances. The user, identified in a stored profile (e.g., in a database accessible to the content authoring system 328) as wheelchair-bound, provides a natural-language prompt such as “Place my toaster somewhere on the kitchen counters where I can reach.” The system may automatically adjust or expand this prompt based on accessibility information in the user's profile, for instance modifying the input to a large-language model so that the input reads “Place the asset so that it is on the kitchen counter but at a depth from the counter edge no more than one foot.” The content authoring system 328 may then process the revised prompt following the same stages described in FIG. 5 (i.e., encoding the 3D scene and the 3D asset, applying the LLM to interpret the prompt, generating a placement mask and a rotation mask, and selecting one or more valid placements). The result may show the toaster positioned on a counter surface that meets accessibility criteria while still matching the spatial and physical layout of the kitchen. In this way, the system supports inclusive and individualized design workflows that take into account user context and physical constraints without requiring manual measurement or object manipulation.

In some embodiments, the content authoring system 328 may include a feedback or clarification loop that operates when a prompt provided by a user is ambiguous. For example, if a user provides a natural-language prompt such as “Place the chair at the table,” the system 328 may determine that the request could correspond to multiple valid positions. The system may then engage in a conversational exchange with the user to obtain clarification. In one implementation, the system 328 may be connected to a third-party chat agent or dialogue interface that specializes in interactive prompting. The system may respond with a question such as “Did you mean the side of the table closest to the kitchen, closest to the patio, or another side?” Based on the user's reply, the system may refine the interpreted spatial constraints and rerun the placement process as shown in FIG. 5. In this way, the content authoring system 328 can iteratively guide users through intermediate reasoning steps (e.g., a “train-of-thought” flow) enabling precise placement even when prompts initially lack sufficient context.

The content authoring system 328 may also extend its placement reasoning to objects suspended from ceilings or other non-horizontal surfaces. For example, the same underlying model architecture depicted in FIG. 5 may be trained to handle assets positioned at various pitch and roll angles, in addition to adjusting yaw around a vertical axis. In one example, the system 328 may process a prompt such as “Hang the lamp from the center of the ceiling above the table” or “Mount the speaker on the wall tilted downward toward the seating area.” By including training data that describes placement on vertical or overhead surfaces, the LLM may learn how terms like “hang,” “mount,” or “tilt” correspond to geometric orientation constraints. During inference, the system 328 may then predict valid attachment points and rotation angles that satisfy these prompts, producing masks for ceiling or wall regions rather than horizontal surfaces. In this way, the architecture may be generalized to position assets at different orientations or contact surfaces throughout a 3D scene, supporting more diverse design use cases.

The content authoring system 328 may accept multimodal input sources, including a camera stream and device pose data, for performing language-guided placement of 3D assets. For example, when a user views the 3D scene through a mobile device, the system may receive camera-pose data describing the device's position and orientation. When the user says a relatively vague command such as “Put the object over there,” the system 328 may use the most recent camera pose to interpret what region of the 3D scene the user is referencing. The camera pose may be passed as an additional input branch to the large language model (e.g., the camera pose 512 input into the LLM 507) so that language, scene geometry, asset features, and user viewpoint can be reasoned about jointly. The combined input allows the content authoring system 328 to infer that “over there” refers to the direction in which the user's device is currently pointed, within a bounded depth range defined by the 3D scene geometry. In this way, the multimodal extension enables point-and-speak authoring experiences, where users can verbally reference areas in the environment without naming explicit anchor objects.

In some embodiments, the described architecture may be applied in use cases where the prompt concerns the positioning of a person or avatar rather than a separate 3D asset. For example, a 3D scene may represent a city landmark such as the Eiffel Tower, and the user may issue a natural-language command like “Where should I stand to take a good picture of the Eiffel Tower?” In this example, the system 328 may analyze the reconstructed 3D scene or a geographic model of the area to identify points meeting specified conditions (e.g., a clear view of the landmark). The system may treat a human or virtual person as the object of placement, determining both an appropriate location and an orientation corresponding to a feasible human pose. The same multimodal reasoning described with respect to FIG. 5 may be used, with the system 328 evaluating geometric visibility and directionality constraints to provide one or more recommended positions where a user or virtual model can stand. Accordingly, the architecture can generalize beyond object placement to determine valid poses or viewpoints satisfying natural-language objectives like capturing a photograph or viewing a landmark.

### Example Methods

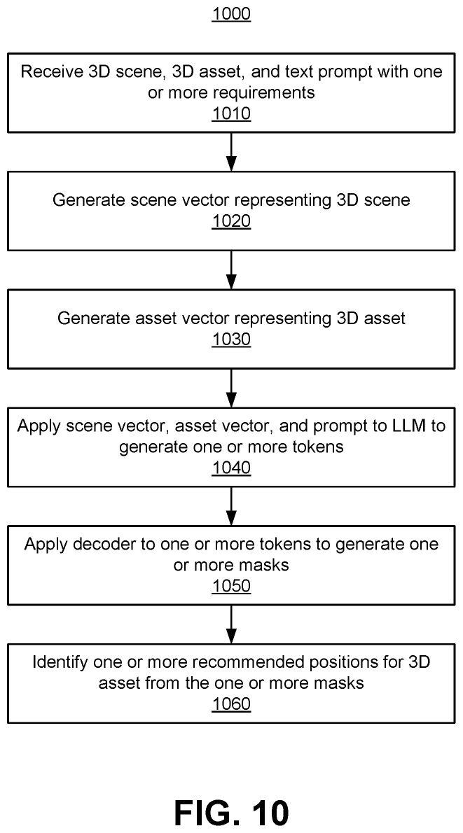

FIG. 10 is a flowchart describing an example method 1000 of authoring content, according to one embodiment. The steps of FIG. 10 are illustrated from the perspective of the content authoring system 328 performing the method 1000. However, some or all of the steps may be performed by other entities or components. In addition, some embodiments may perform the steps in parallel, perform the steps in different orders, or perform different steps.

In the embodiment shown, the method 1000 begins with the content authoring system 328 receiving 1010 an identification of a 3D scene, an identification of a 3D asset to be placed in the 3D scene, and a natural language text prompt including one or more requirements for the positioning of the 3D asset in the 3D scene. The system may also receive data representing a camera pose associated with a camera that captured the 3D scene, the camera pose corresponding to a position and orientation of the camera. The data representing the camera pose may be applied as an additional input during language processing to provide spatial context for interpreting references in the prompt. In some embodiments, the natural-language text prompt and the scene information may be received from a user via a client device or a remote data source.

The content authoring system 328 generates 1020 a scene vector representing the 3D scene. The content authoring system 328 may generate 1020 the scene vector by extracting a first set of features corresponding to points of a 3D point cloud representing the 3D scene and a second set of features that include positional embedding features indicative of spatial location. These point-wise and positional features may be combined to produce a set of combined point-wise features that describe geometry and color for each point in the 3D scene. In some embodiments, the system 328 may identify center points from the point cloud, assign each surrounding point to its nearest center point according to Euclidean distance, and aggregate the combined features of the points associated with a given center point to produce a region-wise feature. The scene vector may then be generated by projecting at least a subset of the combined point-wise or region-wise features into an embedding space used by an LLM.

The content authoring system generates 1030 an asset vector representing the 3D asset. The content authoring system 328 may generate 1030 the asset vector representing the 3D asset by extracting a set of asset features corresponding to points of a 3D point cloud representing the 3D asset, applying a pooling operation to create a single aggregated asset feature, and combining the single aggregated asset feature with a size feature derived from the 3D dimensions of the asset to form a combined asset feature. The combined asset feature may then be projected into the same embedding space of the LLM.

The scene vector and the asset vector are applied 1040 as input to an LLM along with the text prompt. The LLM generates one or more tokens. The tokens may be generated in response to receiving the natural language prompt including requirement(s) for positioning the 3D asset in the 3D scene. The tokens may include a location token, a rotation token, and optionally (e.g., during training), an anchor token that collectively represent spatial and contextual features understood by the model from the input prompt. Each token may encode features relevant to identifying regions in which the asset can be positioned, orientations that the asset can take, or objects that influence placement as described in the natural-language prompt.

The content authoring system 328 applies 1050 a decoder to the tokens to generate one or more masks (e.g., the previously-described location mask, orientation mask, and anchor mask) that indicate valid positions for the 3D asset in view of the requirements included in the text prompt. The decoder may generate the one or more masks using the tokens. The decoder may generate updated tokens through self-attention operations that capture relationships among the tokens and perform cross-attention between those updated token and an output feature determined using features of the asset and the scene. In particular, the decoder may determine the output feature by concatenating combined point-wise or region-wise scene features with a combined asset feature and processing the concatenated vector using one or more MLPs. The output of the cross-attention operation(s) may be context-enhanced token features, where each context-enhanced token feature may be passed to a corresponding mask head. Each mask head may be configured to output a respective mask, such as a location mask or a rotation mask. Each mask may contain numerical values that indicate valid positions and orientations for the asset in view of the input prompt.

Based on the generated masks, the content authoring system 328 identifies 1060 one or more recommended positions for the 3D asset in the 3D scene for presentation to the designer who provided the prompt. Each recommended position may define a full spatial pose of the asset having six degrees of freedom, including three translational coordinates representing the position of the 3D asset on a surface of the scene and three rotational coordinates representing the orientation of the 3D asset in that position. In some embodiments, the rotational coordinates may include a yaw angle about a vertical axis. The content authoring system 328 may then cause a graphical user interface to display a rendering of the 3D scene with the 3D asset placed and rotated at one of the recommended positions, enabling a user or designer to view, edit, or confirm the placement result.

The method 1000 may be used in the field of robotics to place 3D assets automatically with a robot based on natural-language instructions. A computing system, such as a robotic control processor or an external server communicating with a robot, may receive an identification of a 3D scene, an identification of a 3D asset to be placed, and a natural-language prompt describing one or more requirements for positioning of the 3D asset in the 3D scene. Using the same process described above, the computing system may generate a scene vector representing the 3D scene and generate an asset vector representing the 3D asset. The scene vector, the asset vector, and the natural-language prompt may then be applied as input to an LLM, which generates one or more tokens in response to receiving the prompt. Those tokens may be applied to a decoder that generates one or more masks relating to the 3D scene, from which the system identifies one or more recommended positions for the 3D asset in the 3D scene.

Once the recommended positions have been identified, the computing system selects a position among the one or more recommended positions and causes a robot to execute a placement operation. The system may transmit command data to the robot either through an onboard controller running the same method 1000 or through a remote server communicating instructions wirelessly. The robot may then navigate to a location represented by the 3D scene within a threshold distance of the selected position and physically place the 3D asset at the position. For example, a warehouse-management application may receive a prompt such as “Place this box between the shelves labeled A3 and B7.” The system may identify valid shelf areas based on the 3D scene geometry and language input, select one position, and send movement commands that actuate the robot's wheels, arms, or grippers to carry the box and deposit it at the selected location. In this way, the model's spatial reasoning enables the robot to interpret human instructions in plain language and translate them into precise, executable movements.

In various implementations, the method 1000 may be executed locally on processors integrated within the robot itself or remotely on a computing server. When performed on a remote server, the server may provide the robot with data encoding actuator commands or path-planning parameters for the robot's kinematics. The robot may then use these commands to move to the designated area, align itself according to the recommended orientation derived from the model's rotation mask, and complete the placement task.

### Example Computing System

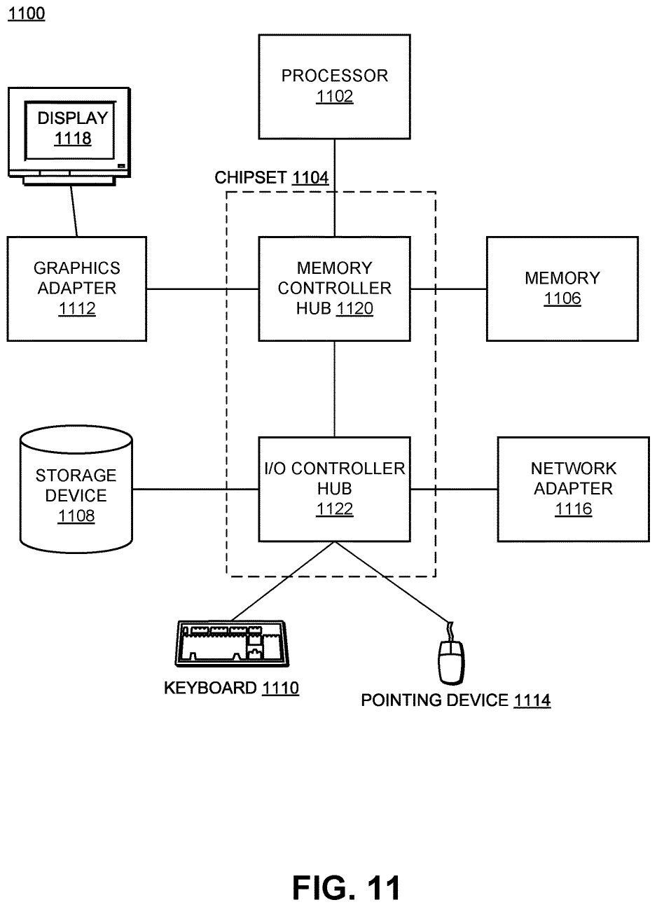

FIG. 11 is a block diagram of an example computer 1100 suitable for use as a client device 310 or an application server 320. The example computer 1100 includes at least one processor 1102 coupled to a chipset 1104. References to a processor (or any other component of the computer 1100) should be understood to refer to any one such component or combination of such components working cooperatively to provide the described functionality. The chipset 1104 includes a memory controller hub 1120 and an input/output (I/O) controller hub 1122. A memory 1106 and a graphics adapter 1112 are coupled to the memory controller hub 1120, and a display 1118 is coupled to the graphics adapter 1112. A storage device 1108, keyboard 1110, pointing device 1114, and network adapter 1116 are coupled to the I/O controller hub 1122. Other embodiments of the computer 1100 have different architectures.

In the embodiment shown in FIG. 11, the storage device 1108 is a non-transitory computer-readable storage medium such as a hard drive, compact disk read-only memory (CD-ROM), DVD, or a solid-state memory device. The memory 1106 holds instructions and data used by the processor 1102. The pointing device 1114 is a mouse, track ball, touch-screen, or other type of pointing device, and may be used in combination with the keyboard 1110 (which may be an on-screen keyboard) to input data into the computer system 1100. The graphics adapter 1112 displays images and other information on the display 1118. The network adapter 1116 couples the computer system 1100 to one or more computer networks, such as network 370.

The types of computers used by the entities of FIGS. 3 and 4 can vary depending upon the embodiment and the processing power required by the entity. For example, the application server 320 might include multiple blade servers working together to provide the functionality described. Furthermore, the computers can lack some of the components described above, such as keyboards 1110, graphics adapters 1112, and displays 1118.

### ADDITIONAL CONSIDERATIONS

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel.

In situations in which the systems and methods disclosed access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. For example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by any claims that ultimately issue.

What is claimed is:

1. A non-transitory computer-readable medium comprising instructions, the instructions, when executed by a computing system, causing the computing system to:
receive an identification of a three-dimensional (3D) scene, an identification of a 3D asset, and a natural language prompt including one or more requirements for positioning of the 3D asset in the 3D scene;
generate a scene vector representing the 3D scene;
generate an asset vector representing the 3D asset;
apply the scene vector, the asset vector, and the natural language prompt as input to a large language model (LLM), the LLM generating one or more tokens in response to receiving the natural language prompt;
apply the one or more tokens as input to a decoder, the decoder generating one or more masks relating to the 3D scene using the one or more tokens; and
identify one or more recommended positions for the 3D asset in the 3D scene using the one or more masks.

2. The non-transitory computer-readable medium of claim 1, the instructions, when executed by the computing system, further causing the computing system to:
receive data representing a camera pose associated with a camera capturing the 3D scene, the camera pose corresponding to a position and orientation of the camera,
wherein the data representing the camera pose is applied as an additional input to the LLM to generate the one or more tokens.

3. The non-transitory computer-readable medium of claim 1, wherein the instructions causing the computing system to generate the scene vector representing the 3D scene comprise instructions, when executed by the computing system, causing the computing system to:
extract a first set of features corresponding respectively to points of a 3D point cloud representing the 3D scene;
extract a second set of features including positional embedding features indicative of spatial location in the 3D scene, the second set of features corresponding respectively to the points of the 3D point cloud;
concatenate the first set of features and the second set of features to produce combined point-wise features; and
project, using at least a subset of the combined point-wise features, the combined point-wise features into an embedding space of the LLM to determine the scene vector.

4. The non-transitory computer-readable medium of claim 3, wherein the instructions causing the computing system to generate the scene vector representing the 3D scene comprise instructions, when executed by the computing system, further causing the computing system to:
identify a plurality of center points from the 3D point cloud;
assign, for each point of the 3D point cloud, a nearest center point of the plurality of center point according to Euclidean distance, wherein a point region represents a given center point and points of the 3D point cloud assigned to the given center point; and
aggregate, for each point region, the corresponding combined point-wise features within the point region to produce a region-wise feature,
wherein the at least a subset of the combined point-wise features used to determine the scene vector corresponds to the region-wise features of corresponding point regions.

5. The non-transitory computer-readable medium of claim 1, wherein the instructions causing the computing system to generate the asset vector representing the 3D asset comprise instructions, when executed by the computing system, causing the computing system to:
extract a set of asset features corresponding respectively to points of a 3D point cloud representing the 3D asset;
aggregate the set of asset features using a pooling operation to produce a single asset feature;
extract a size feature of the 3D asset based on 3D dimensions of the 3D asset;
aggregate the single asset feature and the size feature to produce a combined asset feature; and
project the combined asset feature into an embedding space of the LLM to determine the asset vector.

6. The non-transitory computer-readable medium of claim 1, the instructions, when executed by the computing system, further causing the computing system to:
determine, using an anchor mask and a location mask of the one or more masks, a location prediction loss indicating a validity of a location at which the 3D asset is placed within the 3D scene and a validity of an anchor region within the 3D scene, the anchor region indicating a relative position of the 3D asset to another object in the 3D scene;
determine, using a rotation mask of the one or more masks, a rotation prediction loss indicating a validity of a rotation angle at which the 3D asset is placed within the 3D scene;
determine an LLM loss corresponding to a comparison of text tokens generated by the LLM to reference tokens corresponding respectively to the location of the 3D asset, the rotation angle of the 3D asset, and the anchor region; and
train the LLM to minimize a combined loss comprising the location prediction loss, the rotation prediction loss, and the LLM loss.

7. The non-transitory computer-readable medium of claim 1, wherein the instructions causing the computing system to apply the one or more tokens as input to the decoder comprise instructions, when executed by the computing system, causing the computing system to:
generate, using self-attention, one or more updated tokens representing interactions among the one or more tokens;
concatenate combined point-wise features and a combined asset feature to produce a concatenated vector, the combined point-wise features determined using a 3D point cloud representing the 3D scene, the combined asset feature determined using a 3D point cloud of the 3D asset;
apply a multi-layer perceptron to the concatenated vector to produce an output feature;
generate, using cross-attention between the one or more updated tokens and the output feature, one or more context-enhanced token features; and
determine the one or more masks using respective mask heads applied to a corresponding context-enhanced token feature of the one or more context-enhanced token features.

8. The non-transitory computer-readable medium of claim 1, wherein the one or more masks relating to the 3D scene comprise:
a location mask representing location likelihood values for respective points of a 3D point cloud representing the 3D scene, each location likelihood value indicating whether a corresponding point is a valid placement location for the 3D asset according to the natural language prompt; and
a rotation mask representing, for each point of the 3D point cloud, rotation likelihood values, each rotation likelihood value indicating whether a corresponding rotation angle is a valid placement angle for the 3D asset at a corresponding point according to the natural language prompt.

9. The non-transitory computer-readable medium of claim 1, the instructions, when executed by the computing system, further causing the computing system to:
cause a graphical user interface (GUI) to be displayed at a client device, the GUI comprising a rendering of the 3D scene with the 3D asset placed and rotated at one of the one or more recommended positions.

10. The non-transitory computer-readable medium of claim 1, wherein a recommended position of the one or more recommended positions comprises:
six degrees of freedom defining a full spatial pose of the 3D asset in the 3D scene, the six degrees of freedom including three translational coordinates and three rotational coordinates,
wherein the three translational coordinates correspond to a planar surface of the 3D scene resulting in the 3D asset placed on top of the planar surface, and
wherein the three rotational coordinates limit rotation to a yaw angle about a vertical axis of the 3D scene.

11. The non-transitory computer-readable medium of claim 1, wherein the 3D asset is virtual.

12. The non-transitory computer-readable medium of claim 1, the instructions, when executed by the computing system, further causing the computing system to:
select a position of the one or more recommended positions; and
cause a robot to:
navigate to a location within a physical environment represented by the 3D scene, the location within a threshold distance of the position, and
place the 3D asset at the position.

13. A computer-implemented method comprising:
receiving an identification of a 3D scene, an identification of a 3D asset, and a natural language prompt including one or more requirements for positioning of the 3D asset in the 3D scene;
generating a scene vector representing the 3D scene;
generating an asset vector representing the 3D asset;
applying the scene vector, the asset vector, and the natural language prompt as input to a large language model (LLM), the LLM generating one or more tokens in response to receiving the natural language prompt;
applying the one or more tokens as input to a decoder, the decoder generating one or more masks relating to the 3D scene using the one or more tokens; and
identifying one or more recommended positions for the 3D asset in the 3D scene using the one or more masks.

14. The computer-implemented method of claim 13, further comprising:
receiving data representing a camera pose associated with a camera capturing the 3D scene, the camera pose corresponding to a position and orientation of the camera,
wherein the data representing the camera pose is applied as an additional input to the LLM to generate the one or more tokens.

15. The computer-implemented method of claim 13, wherein generating the scene vector representing the 3D scene comprises:
extracting a first set of features corresponding respectively to points of a 3D point cloud representing the 3D scene;
extracting a second set of features including positional embedding features indicative of spatial location in the 3D scene, the second set of features corresponding respectively to the points of the 3D point cloud;
concatenating the first set of features and the second set of features to produce combined point-wise features; and
projecting, using at least a subset of the combined point-wise features, the combined point-wise features into an embedding space of the LLM to determine the scene vector.

16. The computer-implemented method of claim 13, wherein generating the asset vector representing the 3D asset comprises:
extracting a set of asset features corresponding respectively to points of a 3D point cloud representing the 3D asset;
aggregating the set of asset features using a pooling operation to produce a single asset feature;
extracting a size feature of the 3D asset based on 3D dimensions of the 3D asset;
aggregating the single asset feature and the size feature to produce a combined asset feature; and
projecting the combined asset feature into an embedding space of the LLM to determine the asset vector.

17. The computer-implemented method of claim 13, further comprising:
determining, using an anchor mask and a location mask of the one or more masks, a location prediction loss indicating a validity of a location at which the 3D asset is placed within the 3D scene and a validity of an anchor region within the 3D scene, the anchor region indicating a relative position of the 3D asset to another object in the 3D scene;
determining, using a rotation mask of the one or more masks, a rotation prediction loss indicating a validity of a rotation angle at which the 3D asset is placed within the 3D scene;
determining an LLM loss corresponding to a comparison of text tokens generated by the LLM to reference tokens corresponding respectively to the location of the 3D asset, the rotation angle of the 3D asset, and the anchor region; and
training the LLM to minimize a combined loss comprising the location prediction loss, the rotation prediction loss, and the LLM loss.

18. The computer-implemented method of claim 13, applying the one or more tokens as input to the decoder comprises:
generating, using self-attention, one or more updated tokens representing interactions among the one or more tokens;
concatenating combined point-wise features and a combined asset feature to produce a concatenated vector, the combined point-wise features determined using a 3D point cloud representing the 3D scene, the combined asset feature determined using a 3D point cloud of the 3D asset;
applying a multi-layer perceptron to the concatenated vector to produce an output feature;
generating, using cross-attention between the one or more updated tokens and the output feature, one or more context-enhanced token features; and
determining the one or more masks using respective mask heads applied to a corresponding context-enhanced token feature of the one or more context-enhanced token features.

19. The computer-implemented method of claim 13, wherein the one or more masks relating to the 3D scene comprise:
a location mask representing location likelihood values for respective points of a 3D point cloud representing the 3D scene, each location likelihood value indicating whether a corresponding point is a valid placement location for the 3D asset according to the natural language prompt; and
a rotation mask representing, for each point of the 3D point cloud, rotation likelihood values, each rotation likelihood value indicating whether a corresponding rotation angle is a valid placement angle for the 3D asset at a corresponding point according to the natural language prompt.

20. A system comprising:
one or more processors; and
a non-transitory computer-readable medium comprising instructions, the instructions, when executed by the one or more processors, causing the system to:
receive an identification of a 3D scene, an identification of a 3D asset, and a natural language prompt including one or more requirements for positioning of the 3D asset in the 3D scene;
generate a scene vector representing the 3D scene;
generate an asset vector representing the 3D asset;
apply the scene vector, the asset vector, and the natural language prompt as input to a large language model (LLM), the LLM generating one or more tokens in response to receiving the natural language prompt;
apply the one or more tokens as input to a decoder, the decoder generating one or more masks relating to the 3D scene using the one or more tokens; and
identify one or more recommended positions for the 3D asset in the 3D scene using the one or more masks.
